(19) United States
(12) Patent Application Publication
(10) Pub. No.: US 2026/0062275 A1
(43) Pub. Date: Mar. 5, 2026

(54) Method and Device for Preparing and Dispensing a Post-Mixed Beverage

(71) Applicant: Heineken Supply Chain B.V., Amsterdam (NL)

(72) Inventors: Eric Richard Brouwer, Amsterdam (NL); Bart Jan Bax, Amsterdam (NL); Jeroen Frank Otto, Amsterdam (NL); Arie Maarten Paauwe, Amsterdam (NL)

(21) Appl. No.: 19/107,225

(22) PCT Filed: Sep. 4, 2023
(86) PCT No.: PCT/NL2023/050454

§ 371 Date: Feb. 27, 2025

(30) Foreign Application Priority Data
Sep. 2, 2022 (EP) 22193719.6

(51) Int. Cl. B67D 1/00; B67D 1/07

(52) U.S. Cl. CPC B67D 1/0021; B67D 1/0044; B67D 1/07

(57) ABSTRACT

Method of preparing and dispensing a post-mixed beverage using a beverage dispensing assembly (100), the method comprising steps of: —mixing together a base liquid (104) with a beverage concentrate (106) to form a primary liquid (111) in a beverage dispenser (102) of the beverage dispensing assembly (100); —mixing together the primary liquid (111) with a volume of secondary liquid (108) comprising ethanol and/or one or more hop compounds to form the post-mixed beverage in the beverage dispenser (102); and—dispensing the post-mixed beverage from a dispensing outlet (120) of the beverage dispenser (102); such that in preparing the post-mixed beverage, the volume of secondary liquid (108) is mixed with the beverage concentrate (106) after the beverage concentrate (106) has been at least partially mixed with the base liquid (104) into the primary liquid (111).

### TECHNICAL FIELD

The aspects and embodiments thereof relate to the field of forming and dispensing a post-mixed beverage formed by mixing a beverage concentrate with a base liquid.

### BACKGROUND

Beverages, such as soft drinks, beers, and cocktails can be consumed at locations different from the location where they are produced. As such, the beverages have to be transported. In order to reduce the mass and volume to be transported, it has been suggested to concentrate the beverage—i.e. reduce the water content—prior to transport. The beverage concentrate may be mixed with a base liquid to obtain a post-mixed beverage, with a concentration, consistency and flavour approximating the concentration, consistency and flavour of the original beverage.

A cartridge, otherwise referred to as container, pod, pouch, or capsule, may be used as a vessel for holding the concentrate beverage. A post-mixed beverage can be prepared by mixing the concentrate with a base liquid such as water. The mixing may take place in a beverage dispenser.

### SUMMARY

It has been observed that the post-mixed beverage may appear hazy after dispensing—i.e. has a high turbidity and/or appears turbid—and/or the post-mixed beverage is not homogenously mixed. The turbidity may be higher than the beverage on which the beverage concentrated is based, and may be undesired for aesthetic reasons and/or other reasons. When the post-mixed beverage is not homogenously mixed, the drinking experience of the user may be negatively affected, for example because the flavour concentration is not equally distributed over the post-mixed beverage.

A general aim is to reduce turbidity of a post-mixed beverage formed by mixing one or more beverage concentrates with one or more base liquids. Preferably, the turbidity is reduced such that the turbidity of the post-mixed beverage corresponds or approximately corresponds to the turbidity of a beverage on which the beverage concentrate has been based. Alternatively or additionally, a general aim is to reduce the number of particles in a post-mixed beverage formed by mixing one or more beverage concentrates with one or more base liquids, for example to improve taste, perceived quality, and/or appearance of the post-mixed beverage

Additionally or alternatively, it is an object to mix beverage concentrate with one or more base liquids, such that a substantially homogenous post-mixed beverage may be obtained. It may further be an object to dispense a post-mixed beverage, instead of dispensing beverage concentrate and base liquid subsequently or simultaneously into a beverage container to be mixed in the beverage container itself. This may for example improve the visual experience of a user viewing the stream of post-mixed beverage coming from the beverage dispenser—similar to a conventional beverage dispenser for dispensing conventional non-post-mixed beverage.

Additionally or alternatively, mixing of ingredients forming the post-mixed beverage may be improved when the ingredients are mixed by and/or in the beverage dispenser, instead of dispensing the ingredients forming the post-mixed beverage individually into a beverage container to be mixed in the beverage container itself. Furthermore, mixing by the beverage dispenser may offer improved control of the mixing process, compared to dispensing the ingredients forming the post-mixed beverage individually into a beverage container to be mixed in the beverage container itself. Mixing of different components forming the post-mixed beverage can generally be referred to as preparing the post-mixed beverage.

In order to achieve at least one of the objects discussed above, a first aspect of the present disclosure provides a method according to claim 1.

In the method, a base liquid is mixed together with a beverage concentrate to form a primary liquid. The primary liquid is in particular formed in a beverage dispenser.

According to the disclosure, additional flavouring, ethanol, or any other compound, in particular hop compound, is added to the primary liquid to form a desired post-mixed beverage, such as a beer. To this end, the method comprises a step of mixing together at least part of the primary liquid with a volume of secondary liquid comprising ethanol and/or one or more hop compounds to form the post-mixed beverage in the beverage dispenser, and a step of dispensing the post-mixed beverage from a dispensing outlet of the beverage dispenser. This allows a beverage concentrate to be used which may have a lower content of ethanol and/or hop compounds compared to previously used beverage concentrates which allowed preparing the post-mixed beverage by mixing one or more base liquids with said beverage concentrate, while still obtaining a post-mixed beverage with the same or similar ethanol and/or hop compounds content as the previously formed post-mixed beverage.

In the method, the volume of secondary liquid is mixed with the beverage concentrate after the beverage concentrate has been at least partially mixed—in other words: diluted—with the base liquid. In the primary liquid, typically a lower concentration of compounds of the beverage concentrate is present compared to the beverage concentrate itself as many compounds in the beverage concentrate will not be comprised by the base liquid.

It will be understood that also embodiments of the method are envisioned wherein the primary liquid is formed by mixing one or more base liquids with one or more beverage concentrates, in any combination thereof. Wherever a singular base liquid and/or singular beverage concentrate is mentioned herein, it will be understood that also multiple base liquids and/or multiple beverages concentrates are envisioned. Additionally or alternatively, one or more volumes of one or more secondary liquids comprising ethanol and/or one or more hop compounds may be mixed together with the primary liquid, in any combination thereof.

It has been surprisingly found that when the beverage concentrate is at least partially mixed with one or more base liquids before mixing ethanol and/or one or more hop compounds with the beverage concentrate, the resulting post-mixed beverage is advantageously more homogeneous compared to a post-mixed beverage wherein the base liquid, beverage concentrate, and ethanol and/or one or more hop compounds are simultaneously mixed and/or compared to a post-mixed beverage wherein the ethanol and/or one or more hop compounds are mixed first with the beverage concentrate, and this mixture is afterwards mixed with one or more base liquids.

The secondary liquid comprises ethanol or one or more hop compounds, or a combination of ethanol and one or more hop compounds. When multiple secondary liquids are used, the multiple secondary liquids may be mixed with the primary liquid in any order. For example, when a first secondary liquid comprising ethanol and a second secondary liquid comprising hop compounds are mixed with the primary liquid, one of the two secondary liquids may be mixed first with the primary liquid, followed by the other of the two secondary liquids, in any combination. Additionally, secondary liquid may comprise any flavouring agent, such as one or more aromatic compounds, esters and/or alcohols, in any combination thereof. In embodiments of the method, multiple secondary liquids may be mixed with the primary liquid.

Preferably, the beverage concentrate is essentially free of ethanol. It has been observed that compared to beverage concentrate which is not essentially free of ethanol, beverage concentrate which is essentially free of ethanol allows the beverage concentrate to be formed with a higher concentration of flavouring agents and/or may be more stable during storage and/or may be less prone to having particles formed in the concentrate, for example formed by proteins or sugars in the beverage concentrate.

However, if the desired post-mixed beverage includes ethanol, ethanol has to be added using a liquid other than the beverage concentrate when the beverage concentrate is essentially free of ethanol. Essentially free of ethanol may for the beverage concentrate be understood as less than 1% ethanol by volume, less than 0.5% ethanol by volume, or even less than 0.05% ethanol by volume. The secondary liquid may comprise ethanol to obtain a desired alcohol-by-volume content of the post-mixed beverage.

In general, the beverage concentrate may have an ethanol content of 0-1 % ABV, a water content of 10-90 wt. %, in particular between 35-80 wt. %, and/or a density of 20 to 60° P, in any combination thereof. Beverage concentrate may in general be obtained for example by nanofiltration, reverse osmosis, forward osmosis and/or freeze concentration. As a further option for any beverage concentrate disclosed here-in, the beverage concentrate may comprise 0-5μg or even 0-1μg of hop compounds per gram of dry matter.

The pH of the beverage concentrate is preferably in the range of 3.0 to 6.0, more preferably in the range of 3.2 to 5.5 and most preferably in the range of 3.5 to 5.0. The beverage concentrate preferably has a water content in the range of 40-75 wt. % and more preferably in the range of 45-70 wt. %. In a preferred embodiment, the beverage concentrate has a density of 24 to 50° P, and more preferably a density of 28 to 42° P.

The riboflavin content of the beverage concentrate is preferably in the range of 250-3,000 μg/L, more preferably 300-2,500 μg/L, more preferably 350-2,200μg/L and most preferably 400-2,000μg/L.

The beverage concentrate preferably comprises 150-5,000 μg/L, more preferably 200-4,000μg/L, even more preferably 250-3,500 μg/L and most preferably 300-3,000μg/L of linoleic acid. Besides linoleic acid, the beverage concentrate typically also contains other fatty acids, such as oleic acid and/or alpha-linolenic acids. Oleic acid is preferably present in the beverage concentrate in a concentration of 300-3,000 μg/L, more preferably 400-2,500 pg/L, even more preferably 500-2,000μg/L and most preferably 600-1,800μg/L.

Alpha-linolenic acid is preferably present in the beverage concentrate in a concentration of 100-1,200μg/L, more preferably 120-1,100 μg/L, even more preferably 150-1,000 μg/L and most preferably 180-900μg/L. The free amino nitrogen (FAN) content of the beverage concentrate is preferably in the range of 60-1,000 mg/L more preferably 80-800 mg/L, even more preferably 90-700 mg/L and most preferably 100-600 mg/L.

The beverage concentrate preferably contains 10-100 g/L, more preferably 12-80 g/L, even more preferably 15-60 and most preferably 18-40 g/L of maltotetraose.

The beverage concentrate may contain maltose in a concentration of 0-20 g/L, more preferably of 0-15 g/L, even more preferably of 0.5-10 g/L and most preferably of 1-8 g/L. In other embodiments, the beverage concentrate may contain maltose in a concentration of 80-400 g/L, more preferably of 100-300 g/L, even more preferably of 140-280 g/L and most preferably of 150-250 g/L

The beverage concentrate may contain maltotriose in a concentration of 1-30 g/L, more preferably of 2-25 g/L, even more preferably of 2.5-22 g/L and most preferably of 3-20 g/L. In other embodiments, the beverage concentrate may contain maltose in a concentration of 80-400 g/L, more preferably of 100-300 g/L, even more preferably of 140-280 g/L and most preferably of 150-250 g/L.

The beverage concentrate may contain 100-1,200 mg/L acetic acid, more preferably 120-1,000 mg/L acetic acid, even more preferably 150-900 mg/L acetic acid and most preferably 180-800 mg/L acetic acid.

In a particular embodiment, the beverage concentrate comprises 100-1,200 mg/L of acetic acid, 0-20 g/L of maltose and 1-30 g/L of maltotriose. In another particular embodiment, the beverage concentrate comprises 0-300 mg/L of acetic acid, 80-400 g/L of maltose and 30-150 g/L of maltotriose.

The beverage concentrate may have a surface tension of at least 42.5 mN/m, more preferably of 43.5-55 mN/m and most preferably of 45-53 mN/m. A high surface tension may be preferred to reduce unwanted foaming. Surface tension is measured using a Kruss 9 tensiometer, equipped with Wilhelmy plate.

The beverage concentrate may contain 0-500 mg/L, more preferably 0-200 mg/L and most preferably 0-100 mg/L dissolved carbon dioxide.

When the beverage concentrate is based on a fermented beverage, the beverage concentrate may be obtained by concentrating a fermented beverage, and/or by brewing a fermented beverage with a high concentration of flavouring agents. The high concentration of flavouring agents may be higher than a typical concentration of flavouring agents for said fermented beverage. For example, when the beverage concentrate comprises four times the flavouring agents per volume compared to a conventional beverage, the concentrate has to be diluted four times to obtain the desired concentration of flavouring agents.

Generally, the beverage concentrate may be essentially free of hop compounds. A beverage concentrate which is essentially free of hop compounds may be obtained by forming the beverage concentrate from a fermented beverage brewed without the addition of hop. Essentially free of hop compounds may be defined as having less than 10 mg/L of hop compounds, having less than 5 mg/L of hop compounds, having less than 2 mg/L of hop compounds, or even having less than 1 mg/L of hop compounds. The high concentration of flavouring agents may result in a high dry matter content in the beverage concentrate, which is higher than a typical dry matter content in a conventional beverage. The high concentration of flavouring agents may be obtained by brewing the fermented beverage with a higher concentration of raw materials such as cereal grains, for example malted barley, wheat, and/or maize, compared to the concentration of raw materials used for brewing a conventional beverage which is typically not mixed with a base liquid before consumption.

The beverage concentrate may in general comprise one or more flavouring agents, for example aimed to mimic the flavour of another beverage. In particular, flavouring agents may be used to mimic the flavour of a fermented beverage, such as a beer, wine, or a cider. A flavouring agent may for example be an aromatic compound, an ester or an alcohol. By mixing one or more flavouring agents, in particular into an aqueous solution, a beverage concentrate may hence be obtained. It will thus be understood that a beverage concentrate may also be formed without a brewing or fermenting process. Typically, the beverage concentrate has a higher viscosity than the base liquid and/or secondary liquid.

The base liquid, or conceivably base liquids, with which the beverage concentrate is mixed to form the post-mixed beverage may be or comprise water or carbonated water. The beverage concentrate may then be used to add additional flavours to the base liquid and/or the secondary liquid may be used to add ethanol and/or one or more hop compounds to the base liquid.

Hop typically comprises chemical compounds such as alpha acids, such as humulones (a-lupulic acids), iso-alpha acids, such as isohumulones, beta acids, such as lupulones, essentials oils, and flavonoids such as xanthohumol. These hop compounds may be of natural origin—i. e from actual hop plants, in particular from flowers of the hop plant Humulus lupulus—or conceivably may be synthesised.

The base liquid and the beverage concentrate may be supplied from separate sources. For example, when the base liquid comprises water, a source for base liquid may be a drinking water supply, such as a faucet for providing tap water. Alternatively, a beverage dispenser may comprise a base liquid reservoir for holding a volume of base liquid. The base liquid may thus be or comprise water, or carbonated water. When essentially uncarbonated water is supplied to the beverage dispenser, the beverage dispenser or beverage dispenser assembly may comprise a carbonator for carbonating the water. Preferably, the water is carbonated prior to the water being mixed with the beverage concentrate. The post-mixed beverage may thus be a carbonated post-mixed beverage.

Beverage concentrate is preferably supplied in the form of a replaceable beverage concentrate container, such as a cartridge, cup, pouch, bag, bag-in-container, bag-in-box, keg, or any other liquid container. A beverage concentrate container may in general hold a volume of beverage concentrate for a single serving of post-mixed beverage, or for multiple servings of post-mixed beverage, for example for producing and dispensing 1 L, 2 L, 5 L or even 10 L or more of post-mixed beverage. For example, the preferred volume of post-mixed beverage to be dispensed as a single serving may be 200 mL, 250 mL, 300 mL, 500 mL, or 568 mL (i.e. 1 pint). Preferably, multiple distinct volumes of post-mixed beverage are dispensed using beverage concentrate from the same beverage concentrate container. A beverage concentrate container may hold more than 100 mL, more than 250 mL, more than 500 mL, more than 1 Litre, or even 2 Litres or more or even 5 Litres or more of beverage concentrate.

The beverage concentrate and the secondary liquid are preferably also supplied from separate sources, such as separate liquid containers. Examples are however also envisioned wherein beverage concentrate and secondary liquid are supplied in a single container, such as a cartridge, cup, pouch, bag, bag-in-container, bag-in-box, keg, or any other liquid container, which single container comprising two separate compartments.

Secondary liquid may be supplied to the beverage dispensing assembly using a replaceable secondary liquid container, such as a cartridge, cup, pouch, bag, bag-in-container, bag-in-box, keg, or any other liquid container. A secondary liquid container may in general hold a volume of secondary liquid for a single serving of post-mixed beverage, or for multiple servings of post-mixed beverage, for example 1 L, 2 L, 5 L or even 10 L or more of post-mixed beverage. A secondary liquid container may hold more than 100 mL, more than 250 mL, more than 500 mL, more than 1 Litre, or even 2 Litres or more or even 5 Litres or more of secondary liquid.

An interface between the beverage dispenser and the beverage concentrate container, and between the beverage dispenser and the secondary liquid container may be different, such that the beverage concentrate container and the secondary liquid container each have their own interface with the beverage dispenser. Alternatively, the interface between the beverage dispenser and the beverage concentrate container, and between the beverage dispenser and the secondary liquid container may be essentially the same, such that a beverage concentrate container and a secondary liquid container may be interchangeably connected to the same interface of the beverage dispenser.

Preferably, the method of dispensing a post-mixed beverage using a beverage dispensing assembly does not require mixing together liquids in a mixing chamber of a beverage dispenser. Mixing chambers may be bulky, hard to clean, and/or a mixing process in a mixing chamber may be hard to control and/or may cause excessive foaming of a beverage inside the mixing chamber. To alleviate at least one of these disadvantages at least partially, the method preferably involves mixing together the base liquid and the beverage concentrate in a dispensing line of the beverage dispensing assembly. Additionally or alternatively, the method may comprise mixing together the primary liquid and the secondary liquid in a dispensing line of the beverage dispensing assembly. Mixing of liquids inside the dispensing line may be referred to as in-line mixing.

Preferably, when two liquids are mixed together, the mixing thus takes place in the dispensing line. As such, the use of mixing chambers may be avoided. Typically, when mixing in a mixing chamber, at least during some time of the mixing, a gas such as air is present in the mixing chamber. The gas forms a head space which is preferably avoided, as it may for example cause excessive foaming and/or cause carbon dioxide to escape a liquid such as a carbonated base liquid.

In general, it will be understood that the dispensing line may be formed by a single conduit, or by a plurality of connected conduits forming the dispensing line. The conduits may be connected to form a network of conduits, with conduits which may be positioned in series and/or parallel. A conduit may for example comprise a tube, for example a flexible or rigid tube, which for example may comprise one or more polymers. Different conduits of the dispensing line may be releasably connected to each other, such that one or more of the conduits may be replaced. Being able to replace a conduit may reduce a need of cleaning said conduit. A maximum flow-through area or cross-sectional area for beverage through the dispensing line may for example be approximately 70 mm² or less, or even 50 mm² or less, or even 40 mm² or less. In other words, an inner diameter of a dispensing line may for example be 9 mm or lower.

In the dispensing line, one or more valves and/or one or more pumps may be positioned which allow controlling of the flow or flows of liquid through the dispensing line. In general, a beverage dispenser may comprise a controller arranged to operate the one or more valves and/or one or more pumps, in particular to control the order and ratio in which the base liquid, beverage concentrate, and secondary liquid are mixed prior to being dispensed as a post-mixed beverage.

To improve mixing of two or more liquids together in the dispensing line, for example mixing base liquid and beverage concentrate or primary liquid and secondary liquid, one or more passive mixers may be used. In general, a passive mixer allows for improved mixing of two liquids. As the mixing improves, a shorter length of dispensing line may be required before the two liquids are sufficiently mixed. A passive mixer requires no external energy input to mix two flows of liquid, except for the pressure on the two flows of liquids allowing the flows of liquids to flow through the passive mixer.

Examples of passive mixers which may be readily applied in any embodiment of the beverage dispenser disclosed herein are a venturi ejector, venturi injector, and a labyrinth mixer

Cleaning the beverage dispenser, and in particular a dispensing line thereof, may be important for hygienic reasons and/or for the taste of the post-mixed beverage, especially for example when the beverage concentrate used has a relatively high sugar content, and/or when different types of post-mixed beverage are dispensed using a single beverage dispenser. It is envisioned to use a flow comprising or consisting of base liquid to flush at least part of the dispensing line of the beverage dispenser. As such, the at least part of the dispensing line may be conveniently cleaned, for example using a flow of water as an example of a base liquid. Preferably, the base liquid input is positioned at an upstream end of the dispensing line, and the entire dispensing line can be flushed using the base liquid.

Additionally or alternatively to using a base liquid to flush at least part of the dispensing line of the beverage dispenser, secondary liquid may be used to flush at least part of the dispensing line. In particular when the secondary liquid comprises ethanol, preferably 40% in volume or more, the secondary liquid may be advantageously used to clean the at least part of the dispensing line in a hygienic manner.

Flushing at least part of the dispensing line with the base liquid may in particular be performed after preparing and dispensing a post-mixed beverage using the beverage dispensing assembly and/or prior to preparing and dispensing a further post-mixed beverage using the beverage dispensing assembly.

Additionally or alternatively to using a base liquid and/or second liquid to flush at least part of the dispensing line of the beverage dispenser, a gas may be used for purging at least part of the dispensing line. The gas may in particular be carbon dioxide, which may be supplied from a same or similar source which is also used for carbonating the base liquid. Purging at least part of the dispensing line with a gas, in particular carbon dioxide, may be performed after preparing and dispensing a post-mixed beverage using the beverage dispensing assembly and/or prior to preparing and dispensing a further post-mixed beverage using the beverage dispensing assembly.

The base liquid, secondary liquid, gas and/or any other flushing fluid may leave the beverage dispenser through the dispensing outlet also used for dispensing the post-mixed beverage. Alternatively, base liquid, secondary liquid, a gas, and/or any other flushing fluid may leave the beverage dispenser through a separate outlet, for example to prevent a user from accidentally mistaking the flushing liquid for post-mixed beverage. The dispensing line may thus further comprise a flushing fluid outlet separate from the dispensing outlet through which any flushing fluid can be discarded.

A volume ratio between the base liquid and the beverage concentrate in the primary liquid may be more than 4, in particular more than 6 or even 8 or more. For example, when the ratio is 4, 200 ml of base liquid and 50 mL of beverage concentrate are mixed, for example to form 250 mL of primary liquid. A volume ratio between the primary liquid and the secondary liquid may for example depend on a desired alcohol-by-volume content of the post-mixed beverage and/or a desired flavour profile of the post-mixed beverage, in particular a bitterness which may be expressed in International Bitterness Units (IBU). The alcohol-by-volume content of the post-mixed beverage may for example be 0.0% or more, 2.0% or more, 4.0% or more, 5.0% or more, or even 7.0% or more.

For forming particular post-mixed beverages, such as post-mixed beer, the primary liquid may comprise one or more proteins. The one or more proteins may in particular be comprised by the beverage concentrate used for forming the post-mixed beverage.

A second aspect of the present disclosure provides a beverage dispensing assembly for dispensing a post-mixed beverage, for example according to any embodiment of the method according to the first aspect disclosed herein. The dispensing assembly comprises a beverage dispenser, comprising a dispensing line with a dispensing outlet, a base liquid input, a beverage concentrate input, and a secondary liquid input. As such, the beverage dispenser is arranged for receiving one or more base liquids, one or more beverage concentrates, and one or more secondary liquids. The beverage dispenser is further arranged for mixing together the received base liquid, the received beverage concentrate and the received secondary liquid into a post-mixed beverage, and for dispensing the post-mixed beverage through the dispensing outlet. By mixing together the received base liquid, the received beverage concentrate and the received secondary liquid, the post-mixed beverage may thus be prepared in and/or by the beverage dispenser.

To improve mixing the base liquid, beverage concentrate, and secondary liquid into a homogeneous post-mixed beverage inside the beverage dispenser—i.e. before the post-mixed beverage exits the dispensing outlet—the beverage dispenser allows the base liquid, beverage concentrate, and secondary liquid to be mixed in a particular order. Preferably, the beverage dispenser allows the beverage concentrate to be diluted first with one or more base liquids to form a primary liquid, and subsequently the beverage dispenser allows the primary liquid to be mixed with secondary liquid comprising ethanol and/or one or more hop compounds.

In general, the base liquid input allows for one or more base liquids to be supplied to the dispensing line. The beverage concentrate input allows for one or more beverage concentrates to be supplied to the dispensing line. The secondary liquid input allows for one or more secondary liquids to be supplied to the dispensing line.

Preferably, the beverage concentrate is supplied from a beverage concentrate container which is replaceable from the beverage dispenser. As such, the beverage concentrate container may be replaced, for example when the beverage concentrate container is empty and/or a different post-mixed beverage is desired which requires a different type of beverage concentrate. The beverage concentrate container may be positioned in a beverage concentrate container receptacle of the beverage dispenser and/or the beverage concentrate container may comprise a connector which can be connected to an interface of the beverage dispenser such that a fluid connection is established between an internal volume of the beverage concentrate container in which beverage concentrate is present and the beverage concentrate input.

The beverage dispenser assembly may further comprise a beverage concentrate conduit fluidly connecting the beverage concentrate container and the beverage concentrate input. The beverage concentrate conduit may be releasably connected to the beverage concentrate container, and as such, when replacing the beverage concentrate container, the beverage concentrate conduit may be reconnected to a further beverage concentrate container.

Additionally or alternative, the beverage concentrate conduit may be releasably connected to the beverage dispenser, in particular to the dispensing line. As such, for example when replacing the beverage concentrate container, the beverage concentrate conduit may be disconnected from the beverage dispenser and discarded, e.g. together with the beverage concentrate container. The beverage concentrate conduit may be connected to the beverage concentrate container in a non-tamperable manner, i.e. if the beverage concentrate conduit would be disconnected from the beverage concentrate container, the beverage concentrate conduit cannot be functionally reconnected to the same or a different beverage concentrate container, in particular in the same manner as the beverage concentrate conduit was previously connected to the beverage concentrate container.

The beverage dispensing assembly may further comprise one or more secondary liquid containers. It is generally preferred to supply secondary liquid to the beverage dispenser from a separate secondary liquid container, which may be replaceable connected to the beverage dispenser. A secondary liquid conduit may be comprised by the beverage dispenser assembly to fluidly connect the beverage concentrate container, in particular an internal volume thereof, with the beverage concentrate input. Similar to the beverage concentrate conduit, the secondary liquid conduit may be replaceable connected to the secondary liquid container and/or the dispensing line.

Preferably, the beverage dispenser is free of mixing chambers for mixing together base liquid and beverage concentrate and/or for mixing together base liquid, beverage concentrate, and secondary liquid. Additionally or alternatively, a maximum flow-through area for fluid through the dispensing line between the base liquid input and the dispensing outlet and/or between the beverage concentrate input and the dispensing outlet is 70 mm².

### BRIEF DESCRIPTION OF THE FIGURES

In the figures,

FIG. 1A schematically depicts a beverage dispensing assembly;

FIG. 1B schematically depicts an example of a dispensing line;

FIG. 2 schematically shows a first embodiment of a beverage dispensing assembly; and

FIG. 3 schematically shows a second embodiment of a beverage dispensing assembly.

### DETAILED DESCRIPTION OF THE FIGURES

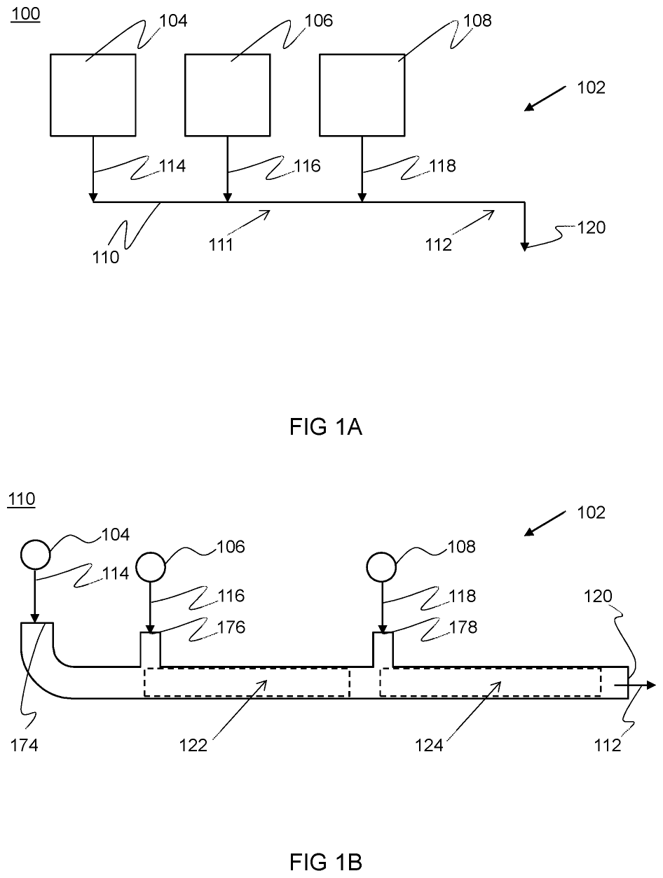

FIG. 1A schematically depicts a beverage dispensing assembly 100 which can be used in a method of preparing and dispensing a post-mixed beverage, such as a post-mixed brewed beverage, in particular a post-mixed beer. The beverage dispensing assembly 100 comprises a beverage dispenser 102, of which a dispensing line 110 is schematically shown in FIG. 1A. A dispensing outlet 120 is provided at a downstream end of the dispensing line 110. In use, preferably homogenously mixed post-mixed beverage can be dispensed from the dispensing outlet 120, for example into a drinking glass or cup.

The beverage dispensing assembly 100 allows for different liquids to be mixed in a particular order, in the beverage dispenser 102. It will be appreciated that the beverage dispenser 102 is only partially depicted in FIG. 1A for clarity and conciseness of the figure.

The beverage dispensing assembly 100 is in FIG. 1A shown comprising a source 104 of base liquid, a source 106 of beverage concentrate, and a source 108 of secondary liquid. The source of base liquid 104 can for example be a container holding water.

From the source of base liquid 104, a flow of base liquid 114 can be supplied to the dispensing line 110. From the source of beverage concentrate 106, a flow of beverage concentrate 116 can be supplied to the dispensing line 110. From the source of secondary liquid 108, a flow of secondary liquid 118 can be supplied to the dispensing line 110. In general, one, two or all of the flows of base liquid, beverage concentrate, and secondary liquid can be supplied to the dispensing line simultaneously or separately, in any combination thereof. A flow of any of the liquids may be constituted for example using one or more pumps and/or valves.

As visualised in FIG. 1A, in the beverage dispenser 102, the source of beverage concentrate 106 is connected downstream of the source of base liquid 104, and the source of secondary liquid 108 is connected downstream of the source of beverage concentrate 106. As such, in the beverage dispenser 102, a post-mixed beverage may be prepared by first mixing the base liquid and the beverage concentrate together into a primary liquid 111, and subsequently mixing the primary liquid 111 together with the secondary liquid to form the post-mixed beverage 112. The post-mixed beverage 112 is preferably essentially homogeneous before being dispensed from the dispensing outlet 120. It has been observed that mixing the secondary liquid comprising ethanol and/or one or more hop compounds with the primary liquid may result in a more homogenous post-mixed beverage, compared to mixing the base liquid with ethanol and/or one or more hop compounds prior to or with mixing the base liquid with beverage concentrate.

FIG. 1B schematically depicts an example of a dispensing line 110 which may be comprised by any beverage dispenser 102 disclosed herein. In general, base liquid can be supplied to the dispensing line 110 from any base liquid source 104, beverage concentrate can be supplied to the dispensing line 110 from any beverage concentrate source 106, and secondary liquid can be supplied to the dispensing line from any secondary liquid source 108.

At or near an upstream end of the dispensing line 110, base liquid from the base liquid source 104 is fed to a base liquid input 174 of the dispensing line 110, for example using a pump and/or by opening a valve (not shown), at a base liquid input 174.

In the particular example of FIG. 1B, beverage concentrate is fed to a beverage concentrate input 176 of the dispensing line 110. As such, in-line mixing of base liquid and beverage concentrate can be achieved, preferably without requiring any mixing chamber. As schematically indicated in FIG. 1B, a first mixing area 122 is provided in the dispensing line 110 downstream of beverage concentrate input 176. In the first mixing area 122, the base liquid is allowed to mix with the beverage concentrate. It will be understood that the first mixing area 122 is positioned inside the dispensing line 110. In the first mixing area 122, optionally, any number of mixing aids may be positioned to improve mixing of the base liquid and beverage concentrate. The mixing aid or mixing aids are preferably passive mixing aids. Further preferably, the base liquid and beverage concentrate are mixed into an essentially homogenous primary liquid, in particular prior to reaching a secondary liquid input 178.

In general, the primary liquid may in itself be a beverage suitable for consumption. For example, the primary liquid may be an essentially non-alcoholic beverage, such as non-alcoholic brewed beverage, in particular a non-alcoholic beer which may be essentially free of one or more hop compounds. A non-alcoholic beverage may generally have an alcohol-by-volume content below 1%, below 0.5%, below 0.1%, or even below 0.05, for example depending on legislation of a particular country or region.

At the secondary liquid input 178, secondary liquid from the secondary liquid source 108 can be fed into the dispensing line 110, in particular at a position downstream of at least part of the first mixing area 122, preferably downstream of the entire first mixing area 122.

Downstream of the secondary liquid input 178, a second mixing area 124 is provided in the dispensing line 110 where the primary liquid is allowed to mix with the secondary liquid. The second mixing area 124 is positioned inside the dispensing lien 110. As such, in-line mixing of primary liquid and secondary liquid can be achieved, preferably thus without requiring any mixing chamber. In the second mixing area 124, any number of mixing aids, preferably passive mixing aids, may be present to improve mixing of the primary liquid and secondary liquid.

At the dispensing outlet 120 of the dispensing line 110, downstream of the second mixing area 124, a preferably essentially homogenous post-mixed beverage 112 can be dispensed out of the outlet 120 of the dispensing line 110.

At the base liquid input 174, beverage concentrate input 176, and/or the secondary liquid input 178, a T-junction, Y-junction, or generally bifurcated junction may be comprised by the dispensing line 110 to allow two fluid flows to be mixed together. A bifurcated junction allows for inline mixing of two fluid flows into a single fluid flow. In general, fluid flows may generally flow in the same or a similar direction prior to being mixed together. More specifically, fluid flows may flow substantially parallel or even substantially coaxially prior to being mixed together. Alternatively, fluid flows may generally flow at an angle relative to each other, but converging towards a same point or area. A fluid flow may for example comprise one or more base liquids, one or more beverage concentrates, one or more primary liquids, and/or one or more secondary liquids.

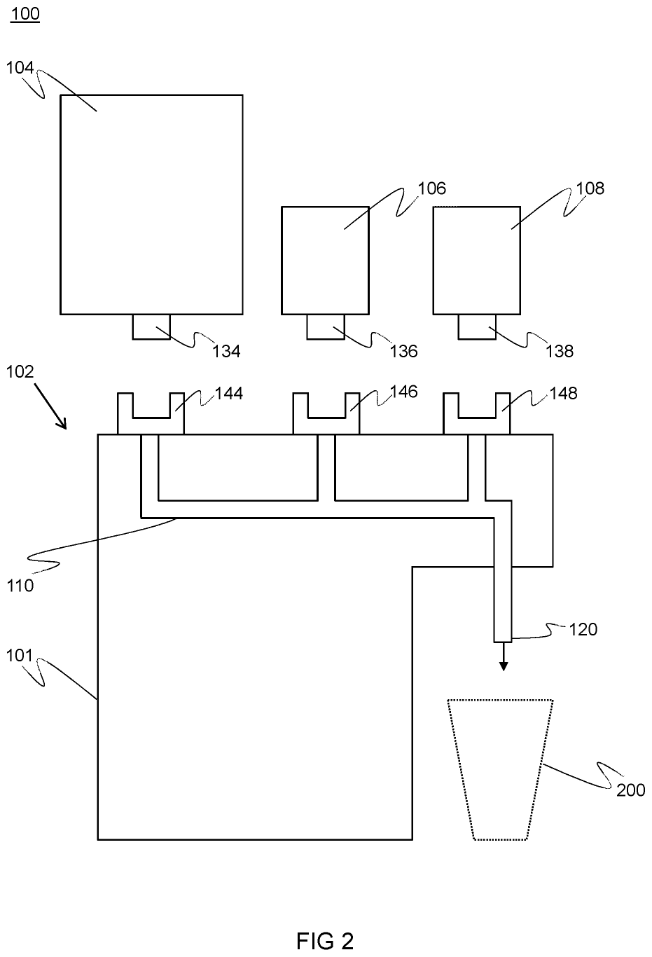

FIG. 2 schematically shows a first embodiment of a beverage dispensing assembly 100 in a partially exploded view. Not forming part of the assembly, but merely shown as an example, FIG. 2 shows a glass 200 which can be filled with post-mixed beverage prepared and dispensed with the beverage dispensing assembly 100. The assembly 100 comprises a beverage dispenser 102, which beverage dispenser 102 typically comprises a housing 101, which housing is only schematically depicted in the figures.

The beverage dispenser 102 comprises the dispensing line 110, to which base liquid, beverage concentrate, and secondary liquid can be supplied, in the particular order as disclosed herein.

For providing a base liquid, the beverage dispensing assembly 100 comprises a base liquid container 104 with a base liquid connector 134 arranged to be operatively connected to a base liquid interface 144 of the beverage dispenser 102.

As a particular option shown in FIG. 2, the beverage dispensing assembly 100 further comprises a beverage concentrate container 106 as an example of a beverage concentrate source. The container 106 can for example be a capsule, pod, pouch, bag-in-container, keg, or any other suitable container. The beverage concentrate container 106 is here as an option provided with a connector 136 with which the container 106 can be operatively connected to a beverage concentrate interface 146 comprised by the beverage dispenser 102.

The connector 136 and interface 146 allow replaceable connection of the beverage concentrate container 106 with the beverage dispenser 102. For example after the beverage concentrate container 106 has been at least partially emptied, the container 106 can be disconnected and for example replaced by a further beverage concentrate container comprising the same type of beverage concentrate, or conceivably another type of beverage concentrate to form a further post-mixed beverage.

As a further particular option shown in FIG. 2, the beverage dispensing assembly 100 further comprises a secondary liquid container 108 as a source of secondary liquid. The container 108 can for example be a capsule, pod, pouch, bag-in-container, keg, or any other suitable container. The secondary liquid container 108 can be operatively connected to a secondary liquid interface 148 of the beverage dispenser 102.

In general, when operatively connecting a container with an interface of the beverage dispenser 102, an internal volume of said container may be placed in fluid communication with the beverage dispenser 102, in particular with the dispensing line 110 thereof.

The connector 138 and interface 148 allow replaceable connection of the secondary liquid container 108 with the beverage dispenser 102. For example after the secondary liquid container 108 has been at least partially emptied, the container 108 can be disconnected and for example replaced by a further secondary liquid container comprising the same type of secondary liquid, or conceivably another type of secondary liquid to form a further post-mixed beverage.

The connectors 134, 136 and 138 and the interfaces 144, 146 and 148 are shown similarly shaped in FIG. 2. Thus, these interfaces may for example be interchangeably used for connecting base liquid containers, beverage concentrate containers or secondary liquid containers to. It will be understood that in any embodiment of the beverage dispensing assembly, the base liquid interface 144 and/or beverage concentrate interface 146 may be incompatible with the connector 138 of the secondary liquid container, and/or the secondary liquid interface 148 may be incompatible with the beverage concentrate interface 136 and/or the base liquid interface 144. As such, it may be prevented that a user accidentally changes the order in which the base liquid, beverage concentrate and the secondary liquid are mixed together in the beverage dispenser 102.

In general, the connection between an interface such as the beverage concentrate interface 146 or secondary liquid interface 148 may be a screw connection, bayonet connection, a twisting or rotational connection, a clamped connection, any other type of connection, or any embodiment thereof.

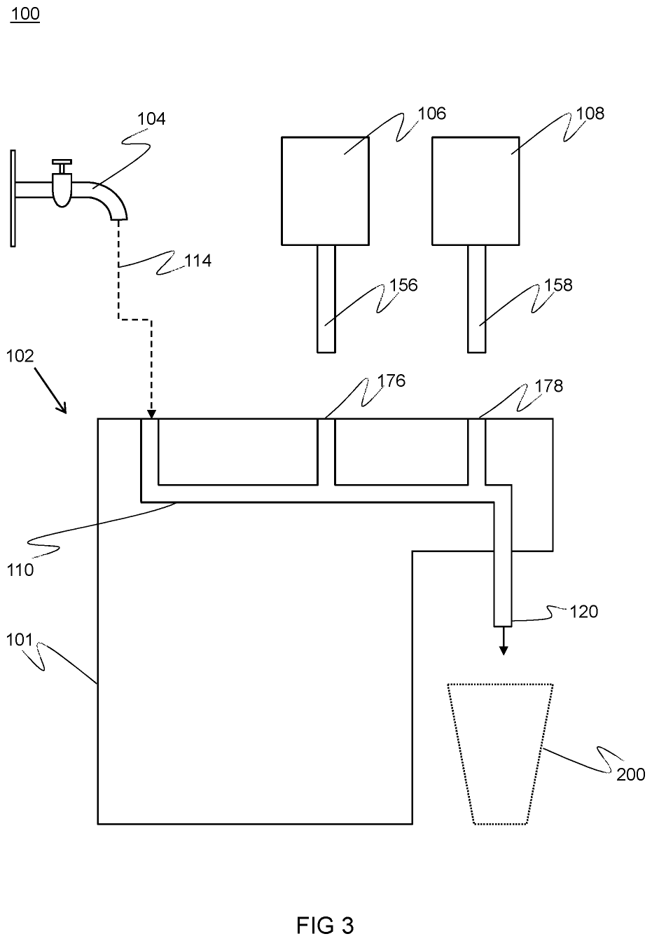

FIG. 3 schematically shows a second embodiment of a beverage dispensing assembly 100 in a partially exploded view. Not forming part of the assembly, but merely shown as an example, FIG. 3 shows a glass 200 which can be filled with post-mixed beverage.

In the particular embodiment of FIG. 3, as an option applicable to any embodiment of the beverage dispensing assembly 100, the base liquid source is a faucet 104 as an example of a tap water supply. A fluid conduit 114, for example a flexible tube, may be comprised by the assembly 100 to be coupled between the faucet 104 and the beverage dispenser 102 such that tap water can be supplied to the dispensing line 110.

As shown in FIG. 3, embodiments of the beverage concentrate container 106 as a beverage concentrate source may comprise a beverage concentrate conduit 156. The beverage concentrate conduit 156 may comprise a flexible conduit, such as a flexible tube, or a spout, in particular a rigid spout. Similarly, as a further option, embodiments of the secondary liquid container 108 as a secondary liquid source may comprise a secondary liquid conduit 158. The secondary liquid conduit 158 may comprise a flexible conduit, such as a flexible tube, or a spout, in particular a rigid spout.

The beverage concentrate conduit 156 is connectable to the beverage concentrate input 176 of the dispensing line 110. This connection may be directly, or indirectly via one or more interconnecting couplers. The secondary liquid conduit 158 is connectable to the secondary liquid input 178 of the dispensing line. This connection may be directly, or indirectly via one or more interconnecting couplers.

It will be understood that any option disclosed in conjunction with the first embodiment of the beverage dispensing assembly may be readily applied to the second embodiment of the beverage dispensing assembly, and vice versa. Furthermore, any other options disclosed herein not directly in conjunction with the first or second embodiment of the beverage dispensing assembly may be readily applied to said first and second embodiments, for example related to the types of post-mixed beverages, types of beverage concentrates, types of secondary liquid, orders of mixing different liquids, types of containers used to supply any liquid to the beverage dispenser, in any combination thereof.

The present disclosure may be summarised in a non-limitative way by means of the numbered embodiments:
1. Method of preparing and dispensing a post-mixed beverage using a beverage dispensing assembly, the method comprising steps of:
mixing together a base liquid with a beverage concentrate to form a primary liquid in a beverage dispenser of the beverage dispensing assembly;
mixing together the primary liquid with a volume of secondary liquid comprising ethanol and/or one or more hop compounds to form the post-mixed beverage in the beverage dispenser; and
dispensing the post-mixed beverage from a dispensing outlet of the beverage dispenser;
such that in preparing the post-mixed beverage, the volume of secondary liquid is mixed with the beverage concentrate after the beverage concentrate has been at least partially mixed with the base liquid into the primary liquid.
2. Method according to embodiment 1, wherein the secondary liquid comprises both ethanol and hop compounds.
3. Method according to any of the preceding embodiments, wherein the beverage concentrate is essentially free of ethanol.
4. Method according to any of the preceding embodiments, wherein the beverage concentrate is essentially free of hop compounds.
5. Method according to any of the preceding embodiments, wherein the base liquid and the beverage concentrate are supplied from separate sources.
6. Method according to any of the preceding embodiments, wherein the beverage concentrate and the secondary liquid are supplied from separate sources.
7. Method according to any of the preceding embodiments, wherein the base liquid is or comprises carbonated water.
8. Method according to any of the preceding embodiments, wherein the beverage concentrate is based on a fermented beverage, in particular a beer.
9. Method according to any of the preceding embodiments, wherein the beverage concentrate is supplied from a beverage concentrate container, such as a capsule, and wherein multiple distinct volumes of post-mixed beverage are dispensed using beverage concentrate from the same beverage concentrate container.
10. Method according to any of the preceding embodiments, wherein the base liquid and the beverage concentrate are mixed together in a dispensing line of the beverage dispensing assembly.
11. Method according to any of the preceding embodiments, wherein the primary liquid and the secondary liquid are mixed together in a dispensing line of the beverage dispensing assembly.
12. Method according to embodiment 10 or 11, further comprising flushing at least part of the dispensing line with the base liquid.
13 Method according to any of the embodiments 10-12, further comprising purging at least part of the dispensing line with a gas, in particular carbon dioxide.
14. Method according to any of the embodiments 10-13, further comprising flushing at least part of the dispensing line with the secondary liquid, in particular wherein the secondary liquid comprises ethanol.
15. Method according to any of the preceding embodiments, wherein a volume ratio between the base liquid and the beverage concentrate in the primary liquid is more than 4, in particular more than 6 or even 8 or more.
16. Method according to any of the preceding embodiments, wherein the primary liquid comprises protein, in particular wherein the beverage concentrate comprises protein.
17. Beverage dispensing assembly for preparing and dispensing a post-mixed beverage, the dispensing assembly comprising a beverage dispenser, the beverage dispenser comprising:
a dispensing line with a dispensing outlet at a downstream end of the dispensing line;
a base liquid input;
a beverage concentrate input; and
a secondary liquid input;
wherein the base liquid input is in fluid communication with the dispensing line, the beverage concentrate input is in fluid communication with the dispensing line, and the secondary liquid input is in fluid communication with the dispensing line, and
wherein the secondary liquid input is connected to the dispensing line downstream relative to the base liquid input and the beverage concentrate input, and the secondary liquid input is connected upstream to the dispensing line relative to the dispensing outlet.
18. Beverage dispensing assembly according to embodiment 17, further comprising a beverage concentrate container, such as a beverage concentrate cartridge, comprising a volume of beverage concentrate, which beverage concentrate container is replaceable connected to the beverage concentrate input.
19. Beverage dispensing assembly according to embodiment 18, wherein the beverage dispenser assembly further comprises a beverage concentrate conduit fluidly connecting the beverage concentrate container and the beverage concentrate input, which beverage concentrate conduit is releasably connected to the beverage concentrate container and/or the dispensing line.
20. Beverage dispensing assembly according to any of the embodiments 17-19, further comprising a secondary liquid container, such as a cartridge, comprising a volume of secondary liquid comprising ethanol and/or one or more hop compounds, which secondary liquid container is releasably connected to the secondary liquid input.
21. Beverage dispensing assembly according to embodiment 20, wherein the beverage dispenser assembly further comprises a secondary liquid conduit fluidly connecting the secondary liquid container and the secondary liquid input, which secondary liquid conduit is releasably connected to the secondary liquid container and/or the dispensing line.
22. Beverage dispensing assembly according to any of the embodiments 17-21, wherein:
the beverage dispenser is free of mixing chambers for mixing together base liquid and beverage concentrate and/or for mixing together base liquid, beverage concentrate, and secondary liquid.
23. Beverage dispensing assembly according to any of the embodiments 17-22, wherein a maximum flow-through area for fluid through the dispensing line between the base liquid input and the dispensing outlet and/or between the beverage concentrate input and the dispensing outlet is 70 mm².

1. A method of preparing and dispensing a post-mixed beverage using a beverage dispensing assembly, the method comprising steps of:
mixing together a base liquid with a beverage concentrate to form a primary liquid in a beverage dispenser of the beverage dispensing assembly;
-mixing together the primary liquid with a volume of secondary liquid comprising ethanol and/or one or more hop compounds to form the post-mixed beverage in the beverage dispenser; and
dispensing the post-mixed beverage from a dispensing outlet of the beverage dispenser;
such that in preparing the post-mixed beverage, the volume of secondary liquid is mixed with the beverage concentrate after the beverage concentrate has been at least partially mixed with the base liquid into the primary liquid.

2. The method according to claim 1, wherein the secondary liquid comprises both ethanol and hop compounds.

3. The method according to claim 1, wherein the beverage concentrate is free of ethanol.

4. The method according to claim 1, wherein the beverage concentrate is free of hop compounds.

5. The method according to claim 1, wherein the beverage concentrate is supplied from a beverage concentrate container, and wherein multiple distinct volumes of post-mixed beverage are dispensed using beverage concentrate from the same beverage concentrate container.

6. The method according to claim 1, wherein the base liquid and the beverage concentrate are mixed together in a dispensing line of the beverage dispensing assembly.

7. The method according to claim 1, wherein the primary liquid and the secondary liquid are mixed together in a dispensing line of the beverage dispensing assembly.

8. The method to claim further comprising flushing at least part of the dispensing line with the base liquid.

9. The method according to claim 6, further comprising purging at least part of the dispensing line with a gas.

10. The method according to claim 6, further comprising flushing at least part of the dispensing line with the secondary liquid, and wherein the secondary liquid comprises ethanol.

11. The method according to claim 1, wherein a volume ratio between the base liquid and the beverage concentrate in the primary liquid is more than 4.

12. The method according to claim 1, wherein the primary liquid comprises protein.

13. A beverage dispensing assembly for preparing and dispensing a post-mixed beverage, the dispensing assembly comprising a beverage dispenser, the beverage dispenser comprising:
a dispensing line with a dispensing outlet at a downstream end of the dispensing line;
a base liquid input;
a beverage concentrate input; and
a secondary liquid input;
wherein the base liquid input is in fluid communication with the dispensing line, the beverage concentrate input is in fluid communication with the dispensing line, and the secondary liquid input is in fluid communication with the dispensing line, and
wherein the secondary liquid input is connected to the dispensing line downstream relative to the base liquid input and the beverage concentrate input, and the secondary liquid input is connected upstream to the dispensing line relative to the dispensing outlet.

14. The beverage dispensing assembly according to claim 13, wherein:
the beverage dispenser is free of mixing chambers for mixing together base liquid and beverage concentrate.

15. The beverage dispensing assembly according to claim 13, wherein a maximum flow-through area for fluid through the dispensing line between the base liquid input and the dispensing outlet is 0.1085 in².

16. The beverage dispensing assembly according to claim 13, wherein the beverage dispenser is free of mixing chambers for mixing together base liquid, beverage concentrate, and secondary liquid.

17. The beverage dispensing assembly according to claim 13, further comprising a beverage concentrate container comprising a volume of beverage concentrate, which beverage concentrate container is replaceable connected to the beverage concentrate input.

18. The method according to claim 1, wherein the beverage concentrate is based on a beer.

19. The method according to claim 1, wherein the base liquid comprises carbonated water.

20. The method according to claim 1, wherein the beverage concentrate comprises protein.
